(19) United States
(12) Patent Application Publication
(10) Pub. No.: US 2015/0249331 A1
(43) Pub. Date: Sep. 3, 2015

(54) LINE ARRESTER

(71) Applicant: SIEMENS AKTIENGESELLSCHAFT, München (DE)

(72) Inventors: Ingo Gottschalk, Berlin (DE); Markus Sulitze, Falkensee (DE)

(73) Assignee: SIEMENS AKTIENGESELLSCHAFT, MUENCHEN (DE)

(21) Appl. No.: 14/430,276

(22) PCT Filed: Sep. 5, 2013
(86) PCT No.: PCT/EP2013/068341

§ 371 Date: Mar. 23, 2015

(30) Foreign Application Priority Data
Sep. 21, 2012 (EP) 12185493.9

(51) Int. Cl. H02H 9/04; H01T 19/02; H02G 7/00

(52) U.S. Cl. CPC H02H 9/04; H02G 7/00; H01T 19/02

(57) ABSTRACT

A line arrester has a discharge column which can be fastened to an overhead line so as to hang. The discharge column can perform an oscillating movement. A corona ring connected to the discharge column has a movement channel, in which a balancing mass that can move along the movement channel is arranged. The balancing mass is configured, in the event of deflections of the line arrester from the resting position, to move along the movement channel against the deflection direction and thus to dampen the deflection of the line arrester.

The present invention relates to a line arrester according to the preamble of patent claim 1.

In areas having a high cloud-to-ground lightning density, there is a particularly high risk to overhead lines in exposed locations, where lightning strikes to poles or overhead lines cause an increased number of faults in the power supply grid. As a result, frequent, brief power outages or even short circuits between the phases of different systems occur.

Line arresters constitute a cost-effective option for preventing or effectively minimizing such problems. Such line arresters are installed on a utility pole in parallel with an insulator. One end of the line arrester is connected to an overhead line carrying high or medium voltage. The other, ground-side end is connected via a ground cable to ground potential, for example, to a utility pole, which is itself grounded. If an overvoltage occurs in the overhead line, for example, due to a lightning strike, it is diverted by the line arrester to ground.

Line arresters are often installed in a suspended manner on the overhead line. External forces, such as those which occur due to wind or earthquakes, may cause them to swing about the attachment point on the overhead line. This is undesirable, since, on the one hand, it results in mechanical stress on the line arrester, and on the other hand, the end of the line arrester carrying the ground potential may come so close to the overhead line that the required insulation gap is undershot. For this reason, it is necessary to damp swinging movements of the line arrester as much as possible.

In EP 1 138 050 B2, this is achieved by a weight being attached to the ground-side end of the line arrester. However, the overall length of the line arrester is increased as a result.

The object of the present invention is to provide a line arrester which has compact dimensions and whose swinging movements are damped in the event of the occurrence of external forces.

This object is achieved via the means of the present invention as claimed in patent claim 1.

A line arrester thereby includes an arrester column which is attachable to the overhead line in a suspended manner. The arrester column may carry out a swinging movement about the suspension point. The arrester column furthermore includes a corona ring. According to the present invention, the corona ring includes a movement channel in which a movable balancing mass is situated along the movement channel. In the event of deflections of the line arrester from the resting position, the balancing mass is designed to move lengthwise along the movement channel, counter to the direction of deflection. For example, if the line arrester is deflected by wind from its normally perpendicular resting position and is induced to swing, the balancing mass in the movement channel will move along the movement channel in the direction relative to the corona ring which is opposite to the deflection, due to the inertia of its mass. The inner friction of the balancing mass and the friction of the balancing mass with the wall of the movement channel cause kinetic energy of the deflection movement to be converted into heat. The deflection movement of the line arrester is thus damped.

Advantageously, the corona ring is situated on a free end of the arrester column. The free end of the arrester column is the end opposite the suspension point, i.e., the end which experiences the greatest deflection from the resting position during movement.

This system causes the balancing mass to act in a particularly effective manner as a swing damper.

In one particularly advantageous embodiment of the present invention, the movement channel is a ring channel. In a circumferential ring channel within the corona ring, the range of movement of the balancing mass is particularly large. It is thus also possible to suppress larger deflections from the resting position in an effective manner.

In an additional advantageous embodiment of the present invention, the balancing mass includes one or multiple solid components. The balancing mass is thus made up of one or multiple materials which assume a solid state at the typical temperatures of between approximately −20° Celsius and 40° Celsius. The balancing mass may have one part or multiple parts, it being possible for the parts to have identical or different compositions. For example, the balancing mass could be made up of steel balls and rubber balls, the steel balls and the rubber balls being arranged in an alternating manner along the movement channel. The steel balls provide the required mass, and the rubber balls ensure the required friction and damping.

The use of the plural “components” below always means the singular “component” as well.

In addition, one advantageous embodiment of the present invention provides that the solid components are formed as bulk material. For example, the balancing mass could be made of sand, iron powder, or a granulate. In this case, the friction of the balancing mass would be particularly high.

In one particularly advantageous embodiment of the present invention, the solid components are formed by rolling or sliding elements. These may be balls or rollers which are able to move in the movement channel in a rolling manner, or ylinder-shaped sliding elements which move in the movement channel in a sliding manner. A particularly good mobility of the balancing mass is thereby ensured.

In one additional embodiment of the present invention, the balancing mass includes one or more liquid components. The balancing mass is thus made up of one or multiple materials which assume a liquid state at the typical temperatures of between approximately −20° Celsius and 40° Celsius. In particular, viscous fluids are particularly well suited for this, since they ensure a particularly high friction between the balancing mass and the wall of the movement channel.

The liquid components may, for example, be water or glycerin or a saline solution or a sugar solution or oils or esters or an ionic liquid, or a mixture thereof. Water is particularly environmentally friendly and easy to handle, but requires additives such as frost protection, depending on weather conditions. Saline and sugar solutions do not require such additives, and their densities may be varied easily. Oils and esters such as rapeseed methyl ester are used in high-voltage technology, for example, as insulating media, and are suitable for wider temperature ranges. The density and viscosity of ionic liquids are easily adjustable and may therefore be adapted well to specific applications.

Particularly advantageously, the balancing mass includes solid and liquid components. The liquid components may be designed to damp a movement of the solid components. For example, steel balls could move in an oil-filled movement channel. As a result, a particularly advantageous combination of mass and damping of the balancing mass would be possible.

The present invention is described in greater detail based on the drawings.

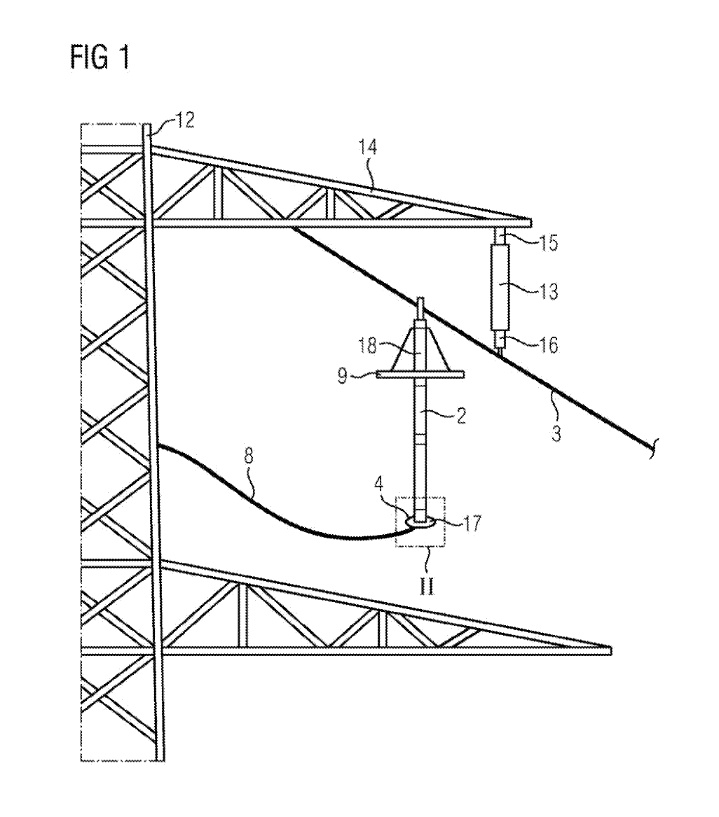

FIG. 1 shows a line arrester installed on an overhead line,

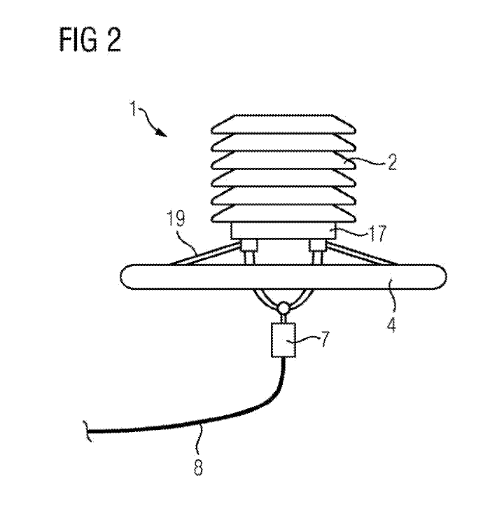

FIG. 2 shows the ground-side end of a line arrester,

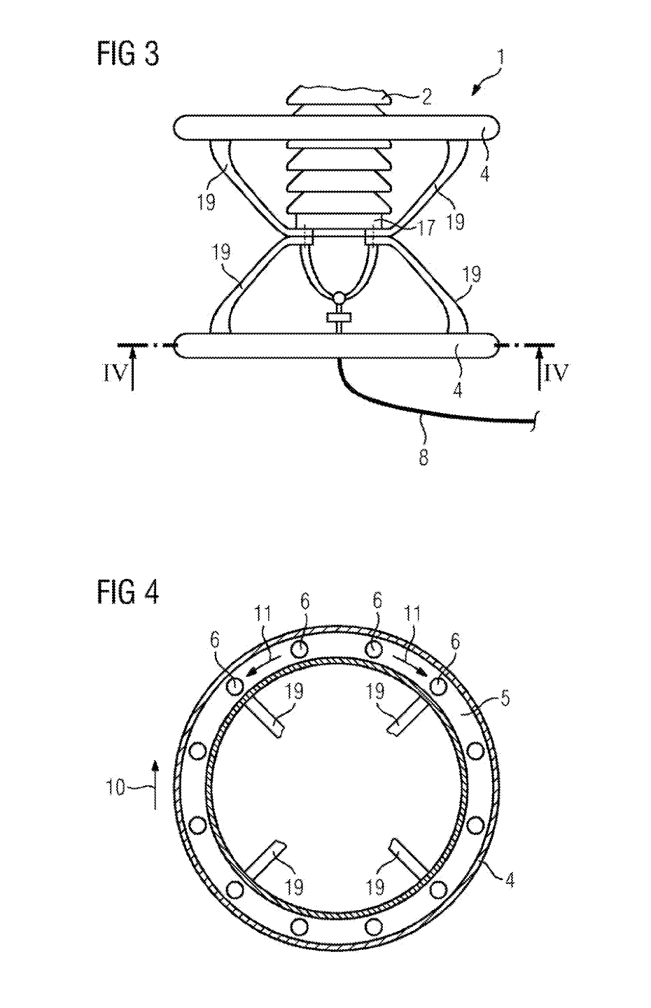

FIG. 3 shows an additional specific embodiment of the ground-side end of a line arrester,

FIG. 4 shows a cross-sectional view of a corona ring of a surge arrester according to the present invention.

Corresponding parts are provided with the same reference numerals in all figures.

FIG. 1 shows an overhead line 3 which is attached to a pole arm 14 of a utility pole 12 with the aid of an insulator 13. The overhead line 3 is an electrical conductor which carries a high or medium voltage. For this purpose, the overhead line 3 is suspended above ground on utility poles 12. Normally, several such electrical conductors, which, for example, may carry different phases, are suspended on a utility pole 12. The utility poles 12 are generally at ground potential. For insulating the live overhead line 3 from ground potential, the overhead line 3 is suspended at a distance from the pole arm 14 by an insulator 13. The insulator 13 is attached to the pole arm 14 on one end by a fitting 15 and has a suspension fitting 16 for the overhead line 3 on the other end.

Without additional protective measures, in the event of lightning strikes to the utility pole 12 or the overhead line 3, there is the risk that one of the insulators 13 will be destroyed and power outages or short circuits will occur. In order to prevent this, a line arrester 1 is situated electrically in parallel with the insulator 13. The line arrester 1 includes an arrester column 2 made of a voltage-dependent resistor, which is bounded by two end fittings. At voltages which occur during the normal operation of the overhead line 3, the arrester column 2 acts as an insulator. If overvoltages occur, which, for example, may be triggered by lightning strikes, the electrical resistance of the arrester column 2 is reduced, and its conductivity increases. For providing mechanical stability, tension elements such as glass fiber rods are fixed between the end fittings 17, 18. To protect against environmental influences, the arrester column 2 is surrounded by a weather-proof, electrically insulating housing, for example, made of silicon or porcelain. The upper end fitting 18 is mechanically and electrically connected to the overhead line 3 via an attachment device. The line arrester hangs down from the overhead line 3. Its lower end having the lower end fitting 17 is able to swing about the attachment point to the overhead line 3. This swinging movement may also be limited to certain directions. Thus, the attachment device may be designed in such a way that swinging movements of the line arrester 1 are possible only in the direction of the overhead line 3, or only perpendicular to it. On the lower, ground-side end of the line arrester 1, a ground cable 8 is attached to the end fitting 17, which, for example, is connected to ground potential via a connection to the utility pole 12. Another disconnecting device 7 may be situated between the end fitting 17 and the ground cable 8, which disconnects the ground cable 8 in the event of a fault in the line arrester 1.

A control ring 9 is situated around the arrester column coaxially to the arrester column 2 and at a distance from the upper end fitting 18. It is attached by braces 18 to the upper end fitting 18 and is used for evening out the distribution of stresses across the overall length of the arrester column 2.

On the ground-side end of the line arrester 2, a corona ring 4 is situated around the end fitting 17 and attached by braces 19 to the end fitting 17. The corona ring 4 acts as a simplified Faraday cage for shielding from often sharp-edged attachment elements in the surroundings of the end fitting 17. Although the control ring 9 and the corona ring 4 have different functions, they are highly similar in design.

FIG. 2 shows the enlarged detail around the ground-side end of the line arrester 1.

FIG. 3 shows the same detail as FIG. 2, using an exemplary embodiment having a double corona ring. Here, two coaxial corona rings 4 are attached to the ground-side end fitting 17.

FIG. 4 shows a radial cross-sectional view of a corona ring. The corona ring 4 is a hollow ring having a circumferential ring channel. It acts as a movement channel 5 for a balancing mass 6. The balancing mass 6 is depicted here as a plurality of balls, only a few balls being shown by way of example. However, the balancing mass may also be made of a bulk material such as sand or a liquid. In most cases, it is expedient that the ring channel is only partially filled with the balancing mass 6 so that a sufficient range of movement still remains for the balancing mass 6. However, if the balancing mass 6 is made up of a composition of a liquid and a solid material, for example, steel balls and oil, the liquid may completely fill the movement channel 5.

In the exemplary embodiment according to FIG. 3, both corona rings 4, or only one of the corona rings 4, may contain movement channels 5 including balancing masses 6. In addition, the control ring 9 may also be provided with a movement channel 5 and a balancing mass 6. In this case, the control ring 9 is a corona ring 4 as defined by the present invention.

In the resting state, the line arrester 1 hangs perpendicularly downward from the overhead line 3. Since the balancing mass 6 is able to move freely in the movement channel 5, it is uniformly distributed. If an external force now acts on the line arrester 1 in the direction of the arrow 10, it is deflected in this direction. Because of the inertia in the frame of reference of the corona ring 4, the balancing mass 6 will move along the movement channel 5 in the direction of the arrows 11 and against the direction of the acting force 10. If the balancing mass 6 is made of multiple parts as depicted here in FIG. 4 by three balls, some balls 6 will move in one direction along the movement channel 5, and others in the opposite direction, depending on their initial position. If the deflection is great enough, the balls 6 moving in different directions along the movement channel 5 will move toward each other and ultimately collide on the opposite end of the movement channel 5, which is designed as a ring channel. The movement of the line arrester 1 is damped due to friction of the balls 6 with each other and with the wall of the movement channel 5 and due to collisions of the balls 6 with each other and with the wall of the movement channel 5. If the line arrester 1 swings back and beyond the resting position, the balancing mass 6 moves in the opposite direction and once again damps the movement. The mechanism for damping using bulk material or liquids is the same as using balls as a balancing mass 6. However, when using liquids as a balancing mass 6, liquids having a suitable viscosity must be used. In particular, if the viscosity is too low, the liquid will slosh around in the movement channel without damping the movement. Under some circumstances, resonance effects may even reinforce the movement rather than damp it.

Balancing masses 6 which consist of metal balls, for example, out of steel or lead, and a liquid such as transformer oil, have proven to be particularly well suited. The balls have a diameter which corresponds to approximately 90% of the diameter of the movement channel, so that the oil is able to flow past the balls. In this respect, the high density of the metal balls provides a particularly high mass, and the oil ensures a particularly high friction, so that a particularly effective damping of the movement of the line arrester 1 is achieved.

1-10. (canceled)

11. A line arrester, comprising:
an arrester column being attachable to an overhead line in a suspended manner, wherein a swinging movement may be carried out via said arrester column; and
a corona ring connected to said arrester column, said corona ring having a movement channel formed therein and a movable balancing mass disposed in said movement channel.

12. The line arrester according to claim 11, wherein said corona ring is situated on a free end of said arrester column.

13. The line arrester according to claim 11, wherein said movement channel is a ring channel.

14. The line arrester according to claim 11, wherein said movable balancing mass includes at least one solid component.

15. The line arrester according to claim 14, wherein said at least one solid component is one of a plurality of solid components each formed from a bulk material.

16. The line arrester according to claim 14, wherein said at least one solid component is one of a plurality of solid components, said solid components selected from the group consisting of rolling elements and sliding elements.

17. The line arrester according to claim 11, wherein said movable balancing mass includes at least one liquid component.

18. The line arrester according to claim 17, wherein said at least one liquid component is one of a plurality of liquid components, said liquid components selected from the group consisting of water, glycerin, a saline solution, a sugar solution, oils, esters and an ionic solution.

19. The line arrester according to claim 11, wherein said movable balancing mass includes solid components and liquid components.

20. The line arrester according to claim 19, wherein said liquid components damp a movement of said solid components.
